(19) United States
(12) Patent Application Publication
(10) Pub. No.: US 2024/0354724 A1
(43) Pub. Date: Oct. 24, 2024

(54) SYSTEM AND METHOD OF ENCOURAGING DONATIVE TRANSFERS THROUGH SETTLEMENTS

(71) Applicant: Silvio REGGIARDO, III, Cameron Park, CA (US)

(72) Inventor: Silvio REGGIARDO, III, Cameron Park, CA (US)

(21) Appl. No.: 18/387,024

(22) Filed: Nov. 4, 2023

Related U.S. Application Data
(60) Provisional application No. 63/577,343, filed on Apr. 18, 2023.

(51) Int. Cl. G06Q 20/10; G06Q 20/38; G06Q 30/0279

(52) U.S. Cl. CPC G06Q 20/10; G06Q 20/389; G06Q 30/0279

(57) ABSTRACT

A system and method of encouraging donative transfers through settlements are disclosed. Example embodiments include establishing, by use of a data processor and a data network, a data connection with a plurality of transaction party platforms involved in settlement of a negotiation or transaction for which completion of performance is necessary for settlement, the performance including completion of a donative transfer of value from one or more of the plurality of transaction party platforms to one or more donees; establishing a data connection between the plurality of transaction party platforms and a central database storing donee information related to available donees; enabling the plurality of transaction party platforms to access the donee information and enabling selection of one or more donees to receive the donative transfer of value; establishing a data connection between the plurality of transaction party platforms and the selected one or more donees to receive the donative transfer of value; effecting the donative transfer of value from the one or more of the plurality of transaction party platforms to the selected one or more donees; and generating evidentiary information as contractual performance evidence verifying completion of contractual or transaction performance.

### PRIORITY PATENT APPLICATION

This non-provisional patent application draws priority from U.S. provisional patent application Ser. No. 63/577,343; filed Apr. 18, 2023. The entire disclosure of the referenced patent application is considered part of the disclosure of the present application and is hereby incorporated by reference herein in its entirety.

### COPYRIGHT

A portion of the disclosure of this patent document contains material that is subject to copyright protection. The copyright owner has no objection to the facsimile reproduction of the patent document or the patent disclosure, as it appears in the Patent and Trademark Office patent files or records, but otherwise reserves all copyright rights whatsoever. The following notice applies to the disclosure, software, and data as described below and in the drawings that form a part of this document: Copyright 2022-2023, Silvio REGGIARDO III, All Rights Reserved.

### TECHNICAL FIELD

This patent application relates to electronic devices and computer-implemented software systems, data collection, storage, and distribution systems, according to example embodiments, and more specifically to a system and method of encouraging donative transfers through settlements and computer systems used to effect donative transfers in connection with negotiation settlement.

### BACKGROUND

The parties negotiating a potential transaction or legal dispute often get close to agreeing on price, but the deal is delayed or fails on matters that, in context, often seem like a minor difference in dollars. In many of those cases, the parties would reach a deal if they could agree that the difference in their proposed prices would not wind up in the pocket of the other party, but would be a donative transfer to an organization that serves publicly-funded purposes, such as a charitable organization, a governmental organization, or a political party or campaign.

### SUMMARY

In various example embodiments described herein, a system and method of encouraging donative transfers through settlements are disclosed. In the various example embodiments described herein, a computer-implemented tool or software application (app) as part of a donative transfer system is described to automate and effect donative transfers in connection with negotiation settlement. As described in more detail below, a computer or computing system on which the described embodiments can be implemented can include personal computers (PCs), portable computing devices, laptops, tablet computers, personal digital assistants (PDAs), personal communication devices (e.g., cellular telephones, smartphones, or other wireless devices), network computers, consumer electronic devices, or any other type of computing, data processing, communication, networking, or electronic system.

In various example embodiments described herein, a donative transfer system and method are described for simultaneously encouraging donative transfers and contract negotiation settlement in a single transaction resulting in an electronic donative transfer as part of contract performance. The various example embodiments are intended to get negotiating parties to “yes” by including a donative component to the transaction. The various example embodiments will allow the parties to have publicly-available and objective Internet information regarding charitable organizations, governmental organizations, and/or political organizations that may receive donative contributions and to provide for an electronic donative transfer arising from conditional computer program instructions as part of settling a contract negotiation or litigation.

The various example embodiments described herein can apply to standard potential transactions for the exchange of value and also the settlement of legal disputes. The former generally involve parties who can cease negotiations without legal repercussions. Legal disputes are different. They involve at least one party who feels it has some sort of personal or economic injury. Such disputes are time-consuming, stressful, and often expensive (particularly if they involve lawyers). If the parties take the dispute to court or the alternative dispute resolution process of arbitration, they cannot know how the matter will be decided. Litigation is inherently uncertain. Parties to a legal dispute—whether in court, arbitration, or simply at the disagreement stage—are generally best off avoiding the time, uncertainty, cost, and stress of full-blown litigation. That is the main reason the vast majority of legal disputes never get to court, or if they do, they settle before trial (sometimes with the assistance of a mediator). In the context of a legal dispute, reaching a settlement agreement often takes too long as the parties wrangle over the last few dollars. As with standard transaction negotiations, offering parties to a legal dispute a way to resolve the dispute in a manner that includes a donative component can be a practical solution to induce settlement.

A donative component can also be included in a negotiation. Purchasers get the satisfaction that goes with donative transfers. Evidence of the human psychology of blending transactions with donative transfers can be found in the many advertisements on Internet retail or auction sites, where sellers (and sometimes even brokers or market-makers) advertise that a portion of the purchase price will go to charity in general or to a particular charity. Sellers know the donative component of the transaction can help make the sale to a potential buyer who would otherwise move on. These transactions allow the potential buyer to decide whether to engage in a simultaneous commercial transaction and donative transfer. But these conventional transactions are rudimentary. They typically involve a designated charitable organization or charitable organizations, rather than a list of candidates or any suggestion based on likely common interests of the parties to a negotiation. They normally do not provide the purchaser with a donation record that could be useful for income tax purposes. They also tend to stay within the charitable arena rather than extend into governmental organizations or political organizations.

It would be desirable to have a process for simultaneously encouraging donative transfers and contract negotiation settlement in a single transaction resulting in a contract and an automatic electronic donative transfer as part of contract performance. Furthermore, it would be desirable to have a process that allows negotiating parties to have publicly-available information regarding charitable organizations, governmental organizations, and political organizations that may receive donative contributions and to provide for an electronic donative transfer arising from conditional computer program instructions as part of settling a contract negotiation. The various example embodiments described herein advantageously fill these needs and address existing deficiencies by combining (1) the extraction of publicly-available Internet information regarding a certain class of potential donees; (2) the execution of a contract providing for the electronic a transfer of value to one or more of those donees as part of contract performance; and (3), when desired, additional applications using modern cryptography (including the potential use of blockchain) to provide secure transaction evidence. The various example embodiments described herein will enhance the operation and utility of computer systems used in connection with donative transfers that are part of commercial transactions. Details of the various example embodiments disclosed herein are provided below and in the accompanying drawings.

### BRIEF DESCRIPTION OF THE DRAWINGS

The various embodiments are illustrated by way of example, and not by way of limitation, in the figures of the accompanying drawings in which:

FIG. 1 illustrates an example embodiment of a networked system in which various embodiments may operate;

FIG. 2 illustrates a schematic relating to the information flow between parties for an example embodiment, in which transaction parties reach settlement with a donative component transferred to a donee;

FIG. 3 illustrates another example embodiment of a networked system in which various embodiments may operate;

FIG. 4 illustrates a processing flow diagram that illustrates an example embodiment of a method as described herein; and

FIG. 5 shows a diagrammatic representation of a machine in the example form of a computer system within which a set of instructions when executed may cause the machine to perform any one or more of the methodologies discussed herein.

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details.

In various example embodiments described herein, a system and method of encouraging donative transfers through settlements are disclosed. In the various example embodiments described herein, a computer-implemented tool or software application (app) as part of a donative transfer system is described to automate and effect donative transfers in connection with negotiation settlement. As described in more detail below; a computer or computing system on which the described embodiments can be implemented can include personal computers (PCs), portable computing devices, laptops, tablet computers, personal digital assistants (PDAs), personal communication devices (e.g., cellular telephones, smartphones, or other wireless devices), network computers, consumer electronic devices, or any other type of computing, data processing, communication, networking, or electronic system.

In various example embodiments described herein, a donative transfer system, implemented on a computer system with a data processor, is described to automate and effect donative transfers in connection with negotiation settlement. Conditional (if this, then that) computer program instructions can be part of a smart contract program on a blockchain, but can also run independent of a blockchain. The general programming techniques are well understood. Searching Internet information with web crawling for Uniform Resource Locators (URLs), web scraping for information within websites, and using other data extraction techniques are processes that continue to evolve (particularly with the assistance of artificial intelligence (AI) applications) but are also common and well understood. The same holds true for modern cryptographic techniques that rely heavily on hashing algorithms and need not but can involve blockchain for an immutable distributed ledger without the need for a trusted third party. The various example embodiments described herein can use these techniques to different degrees (depending on the particular embodiment) in conjunction with a limited but critical set of databases as discussed below.

### Three Types of Potential Donees

In an example embodiment, there are three types of organizations that may receive donative contributions, alone or in some combination: (1) organizations defined as charitable organizations for federal income tax purposes, (2) governmental organizations, and (3) organizations defined as political organizations for federal income tax purposes. Each type of potential donee is described below.

### Charitable Organizations

Internal Revenue Code (IRC) Section 170(c)(2) defines a “charitable contribution” in relevant part to include a gift for certain purposes to “[a] corporation, trust, or community chest, fund, or foundation—
(A) created or organized in the United States or in any possession thereof, or under the law of the United States, any State, the District of Columbia, or any possession of the United States; and
(B) organized and operated exclusively for religious, charitable, scientific, literary, or educational purposes, or to foster national or international amateur sports competition (but only if no part of its activities involve the provision of athletic facilities or equipment), or for the prevention of cruelty to children or animals . . . ”

Such an organization is referred to herein as a “Section 170(c)(2) Organization.” Any organization desiring Section 170(c)(2) Organization status so it can accept tax-deductible charitable contributions files an exemption application with the Internal Revenue Service (IRS), which determines whether the organization meets the requirements (or no longer meets them) and publishes a publicly available list of such organizations in good standing in IRS Publication 78, which has been searchable online since 2018. Taxpayers and their advisors who want to know whether a contribution to an organization may be tax deductible can search this publication. Publication 78 also has a tax deductibility section that indicates whether a charity is a private foundation (subject to special deduction limitations and potential self-dealing penalties) or a public charity that that is not subject to these limitations. Those who want to ensure they are making contributions to public charitable organizations rather than private foundations can specify the donee type. The National Institute of Health (NIH) Ethics Office has issued a publication, “Searching IRS Publication 78 Data on the IRS Website,” which identifies private foundations, stating in part that “[t]his is relevant in the Government ethics arena because of the IRS ruling prohibiting certain federal employees from engaging in ‘acts of self-dealing’ with private foundations, generally meaning foundations which do not accept donations from the public” (see https://ethics.od.nih.gov/sites/default/files/IRS-Pub78-Search.pdf).

### Governmental Entities

IRC Section 170(c)(1) also defines a “charitable contribution” to include a gift for certain purposes to “[a] State, a possession of the United States, or any political subdivision of any of the foregoing, or the United States or the District of Columbia . . . ” Such an organization is referred to herein as a “Section 170(c)(1) Organization.” Congress has determined that contributions to those governmental entities, like charitable contributions, merit an income tax deduction if the funds are used for governmental purposes. Although the IRS does not maintain a single list of such governmental entities, many public governmental entity lists are maintained by the federal government, the States, and State political subdivisions.

### Political Organizations

A “political organization” as defined in IRC section 527 (which became effective in 1975) is generally exempt from income taxes under that statute. Such an organization is referred to herein as a “Section 527 Organization.” With limited exceptions, each Section 527 Organization files IRS Form 8871, Political Organization Notice of Section 527 Status, if it wants to be treated as tax-exempt under IRC section 527. When exceptions apply, other publicly available Internet information is generally available with respect to the organization. Form 8871 (and also Form 8872 relating to the reporting of contribution receipts or expenditures for exempt functions) is available online for public inspection (see IRS.gov/polorgs).

A critically important part of limiting potential donees to organizations within one of these three categories (i.e., (1) a Section 170(c)(2) Organization, (2) a Section 170(c)(1) Organization, or (3) a Section 527 Organization) and the related public databases (referred to herein as the “Critical Databases” to distinguish them from the Central Database described below or databases in general) is that potential donees in these categories (1) serve publicly-funded purposes; (2) are found in publicly-available and searchable Internet databases; and (3) can be objectively identified based on this database information at the time of settlement negotiations and, if desired, contract performance. These are not individuals, or entities that might not have primary public purposes, such as, for example, many tax-exempt organizations described in IRC section 501(c) (other than section 501(c)(3)). These organizations in the Critical Databases have the primary public purposes associated with charitable organizations, governmental organizations or political organizations that further our democratic system of government. A donative transfer might or might not provide the transferor with tax benefits, depending on a variety of factors that in some cases cannot be easily determined during a negotiation, if at all. Donations to political organizations are not deductible for income tax purposes. Being able to identify a potential donee within one of these three categories (and as a public charity or private foundation within the charity category) may be useful from a tax standpoint to at least one party; but, any particular tax treatment is not critical to the various example embodiments described herein.

### General Process

The general process relating to the various example embodiments described herein may be described as follows. The parties to a negotiation for the exchange of valuable consideration will be afforded access to the electronically searchable database (the “Central Database”) that includes only potential donees from the Critical Databases. The parties will enter into an agreement settling the negotiation.

The parties will make at least one set of conditional computer programming instructions (in that agreement or separately under it) to a central processing unit, providing for the transfer of money or other property for less than full consideration to an organization identified in one of the Critical Databases as part of the settlement. In accordance with the settlement agreement at least one party will make that donative transfer. Pursuant to the settlement agreement, the parties to the negotiation will be afforded access to electronic evidence of the donation and the settlement. Donees sign up to receive electronic deposits or payments, a process similar the one used by retailers selling in online marketplaces and auction sites. In many cases there will be other parties (such as online marketplaces, auction sites, and credit card companies) in the transaction. In some instances (such as with credit cards) the purchaser will borrow funds to make the purchase, and other parties will be paid for their participation. The settlement agreement can be part of other agreements (such as terms of service agreements of online marketplaces or auction sites).

### Relying on Laws

Even though the various example embodiments described herein turn on the existence of laws and related public information that may change rather than immutable laws of science, basing an invention of this nature on that legal framework will likely have the same practical effect as if the invention were based on such immutable laws. Charitable organizations, governmental organizations and political organizations have a long history and are here to stay. Donations to them serve a useful public purpose worthy of encouragement. The charitable contribution income tax deduction arose in 1917 through Public Law (P.L.) 65-50, just four years after Congress ratified the Sixteenth Amendment to the United States Constitution in 1913 to allow the first federal income tax. As indicated above, IRC section 567, relating to political organization tax exemption, took effect nearly fifty years ago. Statutes might be replaced and renumbered but any replacements or modifications of IRC section 170(c) or IRC section 567 and the related public databases are highly likely to be fundamentally the same over all relevant periods. The identification of an organization in any of the Critical Databases is entirely objective, which is a critical part of the various example embodiments described herein. Therefore, it is appropriate to use these public Critical Databases as part of a practical solution as described above.

### Information Silos

The processes for storing, retrieving and transmitting data in digital form for the various example embodiments described herein continue to evolve but currently suffice for this purpose and are well understood. The databases identifying any Section 170(c)(2) Organization, Section 170(c)(1) Organization, or Section 527 Organization are public information (as they must be for the various example embodiments described herein).

What is far from obvious is how various components of the various example embodiments described herein relate to each other. This is due to well-separated information silos. For example, in the context of settling commercial transactions, software engineers would not generally understand contract negotiation and consummation or appreciate the existence of the Critical Databases. Those knowledgeable about these tax classifications typically are tax return prepares and advisors who might know about some of the Critical Databases but would use them for tax purposes rather than selecting potential donees. And these professionals generally will not understand the other aspects of the various example embodiments described herein. The information divide becomes even more pronounced in the context of settling legal disputes. Lawyers who handle litigation and related settlements understand the process of negotiating and documenting legally binding settlements. However, they generally do not understand how computer systems can be used in this manner and they generally do not know about the Critical Databases. Those with the necessary database-related knowledge generally do not understand the process and contract law relating to the settling legal disputes, and if the settlement involves the automatic filing of settlement documents with a court, their lack of information becomes even more pronounced. These information silos become even greater in the context of using blockchain or other modem cryptography as a way to securely effect and prove the occurrence of a settlement (particularly a legal dispute settlement), or using AI applications in this process. The components of the example embodiments are multidisciplinary and their combination would not be obvious to any of these participants. The various example embodiments described herein draw from very disparate knowledge bases. It provides a practical and unconventional solution to an industry problem.

### Business Model

The various example embodiments described herein are commercially viable. Commissions can be charged on transactions employing it, and advertising on websites using it can also generate revenue. The Critical Database information can be made publicly available even to those not contemplating a negotiation. This would increase public awareness of (and use of) the various example embodiments described herein while at the same time benefiting the public, and advertising to those in the public accessing the information could be a source of revenue.

### Functional and Structural Differences of the Various Example Embodiments

The various example embodiments described herein are unique when compared with other known processes and solutions, which offer a very limited choice of potential donees or causes (often just one). The various example embodiments described herein can offer parties to a negotiation information from a Central Database with a multitude of potential donees and causes, in some cases with those donees and causes matched to the parties' donative objectives. More specifically, the various example embodiments can rely on computer systems and data networks, with conditional programing instructions and in some cases modern cryptography that will include blockchain smart contracts.

### Description of Various Example Embodiments

Reference is made to the background presented above. The example embodiments disclosed herein provide a system and method of simultaneously encouraging donative transfers and contract negotiation settlement in a single transaction resulting in an electronic donative transfer as part of contract performance. The basic form of the various example embodiments described herein may include the following steps. The parties to the negotiation are given access to Central Database information about Section 170(c)(2) Organizations, Section 170(c)(1) Organizations, and/or Section 527 Organizations that those organizations provide or that is extracted from the Internet with a data extraction central processing unit (CPU). That information is reasonably necessary to make a decision regarding a donative transfer that is a condition under a settlement agreement providing for contractual performance through an exchange of valuable consideration and the donative transfer to at least one such organization (which has arranged to receive an electronic donative transfer) and that includes conditional programing instructions to another CPU (the “Main CPU”) that executes the instructions necessary for the electronic portion of contractual performance and the donative transfer once it receives information that the exchange of valuable consideration has occurred.

At that point the Main CPU sends contractual performance evidence to the parties. In a more complete version of the various example embodiments described herein there would be various options, some of which are discussed below.

### Donor-Donee Matchmaking

Providing negotiating parties with potential donee information can be a simple or complex process. Simple approaches include providing a list of potential donees or donees with particular causes, without taking into account negotiating party identity and likely donee preferences. That is a very hit or miss and inefficient approach. Giving the parties a list of questions to determine preferences (for the particular transaction or for storage in a database for future transactions) would increase the likelihood of finding a match. For example, the combination of personal interest and demographics responses along with information regarding the nature of a transaction might show a high statistical chance the parties would want to support animal causes or a particular animal rescue effort, the election of a particular political candidate, or construction of a particular parks and recreation department youth sports facility (e.g., a “build a ballpark” donation option on a transaction website for potential donors who may have a particular interest in funding that type of project). AI applications can make that process more efficient.

Charitable donations are not made nearly equally among public charitable organizations. A relatively few number of such charitable organizations receive a disproportionate amount of the donations and market heavily, including on the Internet. Information regarding those charitable organizations and their projects is easy to find for the Central Database through standard data extraction techniques. Potential donees could also send particular need information to the Central Database. For example, a public or nonprofit hospital that needs funds for a particular unit or scholarship/fellowship, or a parks and recreation department seeking fund to build a youth facility, could essentially advertise the need by sending relevant information to the Central Database. Web crawling for relevant URLs, web scraping for particular relevant data, and other data extraction techniques could provide relevant Central Database information for the negotiating parties. Websites can allow potential buyers to search for chosen donees or causes and then focus on sellers who are a match. Those making a market through a website can, for a variety of reasons, decide to exclude potential donees. The parties can direct that the donation be used for the donee's general purposes or for specific purposes, and the process can even involve donee follow-up regarding use of funds (which could be relevant for tax and other purposes).

### Modern Cryptography

Typical online transactions involve encrypted data, particularly in connection with credit card transactions. The various example embodiments described herein can include additional aspects of modern cryptography. For settlements that involve the standard purchase and sale of goods with modest value, there is no need for blockchain evidence, or blockchain use would take too much computing power to be justified. With relatively large transactions or legal dispute settlement, the use of blockchain smart contracts for a fully automated and secure transaction with immutable proof and no need for a trusted third party may be useful, and at least one party may insist upon it. With relatively large transactions, donation funds could essentially be escrowed pending full performance, in which event a blockchain transaction could be useful. However, in most instances the nature of the transaction will not necessitate a distributed ledger as a practical matter. To save required computer power and cost, the more practical solution will normally be to store the transaction information in a central database and to prove the integrity of data transfers with simpler hashing approaches or even still simpler approaches such as using check sums or byte counts. Hashing can be relatively simple (using standard algorithms) and yet be very useful. For example, hashing data and circulating the results or placing them in a database available to the parties (and others if desired) can allow for secure verification that all participants received the same data or even that a particular funds transfer or other transaction under the settlement agreement occurred. In the context of executed documents or documents filed with a court, for example, hashing the data can eliminate the need for redlining documents to look for any changes from one version of a document to another, or to verify that a final document was identical to the final draft. In some instances, such proof will not be required as a practical matter and the participants will be satisfied with more standard verification (such as copies of receipts or other documents), but that option using modern cryptography will be available. In any event, conditional computing (using an “if this, then that” programming approach to smart contracts) can be used.

### Forms and Automatic Notices.

Some settlement agreements and related documents will be complicated and not suitable for forms, but others will be more straightforward and forms could be useful. The parties can be allowed access to a separate database with forms, such as settlement agreements or gift agreements. The process can even involve automatic notice of a transaction to third parties when appropriate or required, and even a donee's automatic issuance of a contemporaneous acknowledgement of a donation when such an acknowledgement is required under IRC section 170(f)(8).

### Computer and Hybrid Transactions

It is possible for all transactions relating to the various example embodiments described herein to be handled digitally. For example, if a county allows the execution and recordation of a deed through blockchain, all transaction documents—from document execution to wire transfers (e.g., to a seller, lender in a loan pay-off and charity) to deed execution and recordation and even the issuance of a title insurance policy—may be handled online. However, transactions will typically involve a hybrid approach that combines some aspects of contract performance (such as party and charity payment) online with other aspects of the transaction being manual. For example, with an online purchase of goods, once the buyer accepts the seller's offer (or the buyer wins or seller accepts the buyer's offer in the context of a bid), there are other steps: the buyer makes payment (typically by credit card), the seller ships the goods (and the buyer commonly receives email notice of shipment), and a delivery service (such as the U.S. mail or a private delivery service) delivers the goods and often sends the parties an email notice of delivery. In that context, the donation could occur electronically at any one of several points, such as shipping, delivery, or after any applicable return period lapses. In the context of other transactions, there is normally delivery of a document of title, such as a vehicle “pink slip” or a real estate deed. As discussed immediately below; in the context of litigation settlement, there are dismissal documents that might be filed with a court manually or electronically if allowed. The various example embodiments described herein will work well within such a hybrid structure and will allow for the donative transfer to occur at any number of points in a transaction following a negotiation settlement.

### Court Filings

Legal dispute settlement typically results in a signed settlement agreement and release. The title and format can vary, but the essential terms include an agreement of the parties that the dispute is settled and they waive further claims against each other relating to the dispute (in many cases the releases are general in nature and include potential claims not actually raised in the dispute). If a plaintiff has filed a complaint in court, the action must be dismissed through the filing of dismissal documents (generally “with prejudice” such that the litigation cannot be reopened).

There is a continuing trend for courts to allow (and in many cases encourage) electronic document filing. The various example embodiments described herein can include automatic court filings of documents relating to the settlement of a dispute.

### Other Embodiments

In broad embodiment, the various example embodiments described herein is a system and method of simultaneously encouraging donative transfers and contract negotiation settlement in a single transaction resulting in an electronic donative transfer as part of contract performance. Although one of ordinary skill is enabled to make and use what is currently considered to be the best mode thereof, the above written description of the various example embodiments described herein will enable those of ordinary skill to understand and appreciate the existence of variations, combinations, and equivalents of the specific embodiment, method, and examples herein. Therefore, the various example embodiments described herein should not be limited by the above described embodiment, method, and examples, but by all embodiments and methods within the scope and spirit of the various example embodiments described herein as claimed.

### Details of an Example Embodiment

In various example embodiments described herein, the donative transfer system provides encouraging donative transfers through settlements and computer systems used to effect donative transfers in connection with negotiation settlement. Details of the various example embodiments are described in more detail below.

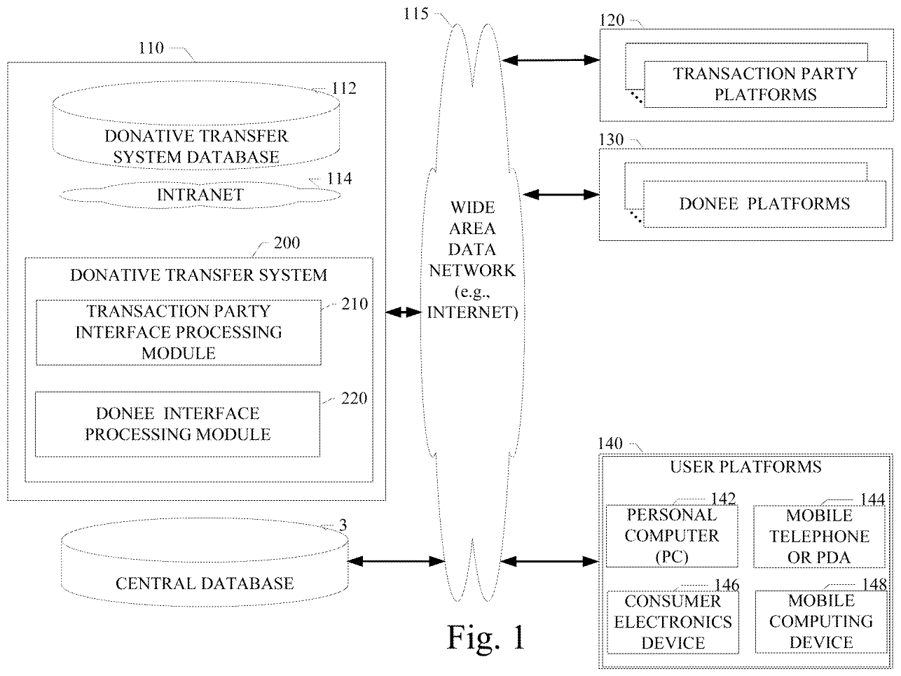

FIG. 1, in an example embodiment, illustrates a system and method of encouraging donative transfers through settlements in computer-implemented manner. In various example embodiments, an application or service, typically provided by or operating on a host site (e.g., a website) 110, is provided to simplify and facilitate the downloading or hosted use of the donative transfer system 200 of an example embodiment. Typically, the donative transfer system 200 can be hosted by the host site 110 for a networked user at a user platform 140. In the example embodiments disclosed herein, the donative transfer system 200 can be managed on behalf of the parties to a transaction by a third-party service provider. The details of the donative transfer system 200 for an example embodiment are provided below.

Referring again to FIG. 1, the donative transfer system 200 can be in network communication with a plurality of transaction party platforms 120, donee platforms 130, and central database 3. Each of the transaction party platforms 120 and donee platforms 130 can be configured like user platforms 140. The transaction party platforms 120 can include user platform computing and/or communication devices, websites, or other network resources at which parties to a transaction can interact with the donative transfer system 200. The term “transaction” as used herein refers to a contract negotiation, litigation matter, or other negotiation where transaction parties are seeking settlement or resolution of an issue. The central database 3 can include networked computing and/or communication devices, data storage devices, websites, or other network resources at which or with which transaction parties can interact in combination with the donative transfer system 200 as described in more detail below. The donative transfer system 200 can be configured to provide data communications (including encrypted data communications) for the user platforms serving as networked platforms for transaction parties to empower transaction parties to communicate in a digital or computer-readable form via the network 115. Additional users of the network ecosystem shown in FIG. 1 operating computing platforms such as user platforms 140 can include auditing parties, escrow agents, finance institutions, legal representatives, or the like.

The donative transfer system 200 may also be configured to provide data communications for the transaction party platforms 120 to enable the networked usage, transfer, or downloading of a transaction party interface processing module 210. The transaction party interface processing module 210 may reside on a transaction party platform 120 or may be downloaded to or from the host site 110. In other words, the transaction party interface processing module 210 may be used, transferred, or downloaded from/to the host site 110 and the donative transfer system 200 therein via the network 115. As such, the transaction party interface processing module 210 may be hosted by the host site 110 or locally resident and locally used by a transaction party platform 120. Similarly, the donative transfer system 200 may also be configured to provide data communications for the donee platforms 130 to enable the networked usage, transfer, or downloading of a donee interface processing module 220. The donee interface processing module 220) may reside on a donee platform 130 or may be downloaded to or from the host site 110. In other words, the donee interface processing module 220 may be used, transferred, or downloaded from/to the host site 110 and the donative transfer system 200 therein via the network 115. As such, the donee interface processing module 220 may be hosted by the host site 110 or locally resident and locally used by a donee platform 130. In an alternative embodiment, the donative transfer system 200 can be configured to use an existing interface that is already provided by a donee platform 130. The donee interface processing module 220 may also be or use an application programming interface (API) that does not require a user present at the donee platform 130.

The donative transfer system 200 may also be configured to provide networked data communications with the central database 3 to enable the networked usage, transfer, or downloading of donee data. In an example embodiment, the central database 3 can represent a repository of information related to the various donees to which donations from one or multiple transaction parties may be made. The central database 3 may also represent existing databases of donee information as described above. The central database 3 may retain donee data in relation to a variety of categories, groupings, topics, genres, or the like that may correspond to particular characteristics or affinities that may align with the characteristics or affinities of the transaction parties using transaction party platforms 120.

One or more of the transaction party platforms 120, the donee platforms 130, and the central database 3 can be provided by one or more third party providers operating at various locations in the network 115 ecosystem. It will be apparent to those of ordinary skill in the art that transaction party platforms 120, the donee platforms 130, and the central database 3 can include or be any of a variety of networked third party information providers/consumers or on-line service providers/consumers as described in more detail herein. In a particular embodiment, a resource list maintained at the host site 110 can be used as a summary or list of all transaction party platforms 120, donee platforms 130, and network resources, which users or the host site 110 may visit/access and from which users or the host site 110 can obtain or store transaction or donee content or related information. The host site 110, transaction party platforms 120, donee platforms 130, central database 3, and user platforms 140) may communicate and transfer data and information in the data network ecosystem shown in FIG. 1 via a wide area data network (e.g., the Internet) 115. Various components of the host site 110 can also communicate internally via a conventional intranet or local area network (LAN) 114.

Networks 115 and 114 are configured to couple one computing device with another computing device. Networks 115 and 114 may be enabled to employ any form of computer readable media for communicating information from one electronic device to another. Network 115 can include the Internet in addition to LAN 114, wide area networks (WANs), direct connections, such as through a universal serial bus (USB) port, other forms of computer-readable media, or any combination thereof. On an interconnected set of LANs, including those based on differing architectures and protocols, a router and/or gateway device acts as a link between LANs, enabling messages to be sent between computing devices. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communication links known to those of ordinary skill in the art. Furthermore, remote computers and other related electronic devices can be remotely connected to either LANs or WANs via a wireless link, WiFi, Bluetooth™, satellite, or modem and temporary telephone link.

Networks 115 and 114 may further include any of a variety of wireless sub-networks that may further overlay stand-alone ad-hoc networks, and the like, to provide an infrastructure-oriented connection. Such sub-networks may include mesh networks. Wireless LAN (WLAN) networks, cellular networks, and the like. Networks 115 and 114 may also include an autonomous system of terminals, gateways, routers, and the like connected by wireless radio links or wireless transceivers. These connectors may be configured to move freely and randomly and organize themselves arbitrarily, such that the topology of networks 115 and 114 may change rapidly and arbitrarily.

Networks 115 and 114 may further employ a plurality of access technologies including 2nd (2G), 2.5, 3rd (3G), 4th (4G), 5th (5G) generation radio access for cellular systems, WLAN, Wireless Router (WR) mesh, and the like. Access technologies such as 2G, 3G, 4G, 5G, and future access networks may enable wide area coverage for mobile devices, such as one or more of client devices 141, with various degrees of mobility. For example, networks 115 and 114 may enable a radio connection through a radio network access such as Global System for Mobile communication (GSM), General Packet Radio Services (GPRS), Enhanced Data GSM Environment (EDGE), Wideband Code Division Multiple Access (WCDMA), CDMA2000, and the like. Networks 115 and 114 may also be constructed for use with various other wired and wireless communication protocols, including TCP/IP, UDP, SIP, SMS, RTP, WAP, CDMA, TDMA, EDGE, UMTS, GPRS, GSM, UWB, WiFi, WiMax, IEEE 802.11x, and the like. In essence, networks 115 and 114 may include virtually any wired and/or wireless communication mechanisms by which information may travel between one computing device and another computing device, network, and the like. In one embodiment, network 114 may represent a LAN that is configured behind a firewall (not shown), within a business data center, for example.

The transaction party platforms 120, donee platforms 130, and/or the central database 3 may include any of a variety of providers or consumers of network transportable digital data. The network transportable digital data can be transported in any of a family of file formats and associated mechanisms to enable a host site 110 and a user platform 140 to send/receive digital transaction or donee data or related data to/from a transaction party platform 120, a donee platform 130, and/or central database 3 over the network 115. In example embodiments, the file format can be a text format, graphic format, image format, video format, audio format, or any related conventional data format. Other file formats and data transport protocols may be used. For example, data formats such as Microsoft™ Access Database Format (MDB), Portable Document Format (PDF), audio (e.g., Motion Picture Experts Group Audio Layer 3-MP3, and the like), video (e.g., MP4, and the like), and any proprietary interchange format defined by specific sites can be supported by the various embodiments described herein. Moreover, a transaction party platform 120, a donee platform 130, and/or a central database 3 may provide or support a variety of different data sets, computational modules, applications, or the like.

Network 115 may further include, or interface with, any of a variety of blockchain or consensus networks. These technologies use encrypted keys and sophisticated decentralized data structures or blockchains to record and validate transactions across a network of distributed computing nodes. The blockchain for a particular implementation must be constantly synchronized between the distributed computing nodes to assure security and validity of the transaction or payment data. The blockchain synchronization, key management, and transaction handling can consume a significant level of processing capacity and device resources on the computing nodes. In many conventional implementations, a trusted third party service is used to manage keys and validate transactions on the blockchain or consensus network.

In a particular embodiment, a user platform 140 with one or more client devices enables a user to access data provided by the donative transfer system 200 via the host 110 and network 115. Client devices of user platform 140 may include virtually any computing device that is configured to send and receive information over a network, such as network 115. Such client devices may include portable devices 144, such as, cellular telephones, smart phones, camera phones, display pagers, radio frequency (RF) devices, infrared (IR) devices, global positioning devices (GPS), Personal Digital Assistants (PDAs), handheld computers, wearable computers, tablet computers, integrated devices combining one or more of the preceding devices, and the like. The client devices may also include other computing devices, such as personal computers 142, multiprocessor systems, microprocessor-based or programmable consumer electronics, network PC's, and the like. The client devices may also include other processing devices, such as consumer electronic (CE) devices 146 and/or mobile computing devices 148, which are known to those of ordinary skill in the art. As such, the client devices of user platform 140 may range widely in terms of capabilities and features. Moreover, a web-enabled client device may include a browser application enabled to receive and to send wireless application protocol messages (WAP), and/or wired application messages, and the like. In one embodiment, the browser application is enabled to employ HyperText Markup Language (HTML), Dynamic HTML. Handheld Device Markup Language (HDML), Wireless Markup Language (WML), WMLScript, JavaScript™, Extensible HTML (xHTML), Compact HTML (CHTML), and the like, to display and/or send digital information. In other embodiments, mobile devices can be configured with applications (apps) with which the functionality described herein can be implemented.

The client devices of user platform 140 may also include at least one client application that is configured to receive digital content and/or control data from another computing device via a wired or wireless network transmission. The client application may include a capability to provide and receive textual data, graphical data, video data, audio data, and the like. Moreover, client devices of user platform 140 may be further configured to communicate and/or receive a message, such as through a Short Message Service (SMS), direct messaging (e.g., Twitter™), email, Multimedia Message Service (MMS), instant messaging (IM), internet relay chat (IRC), mIRC, Jabber, Enhanced Messaging Service (EMS), text messaging, Smart Messaging, Over the Air (OTA) messaging, or the like, between another computing device, and the like.

Referring again to FIG. 1, the donative transfer system 200 for an example embodiment is shown to include a donative transfer system database 112. The donative transfer system database 112 can be used to retain a variety of information data sets including, but not limited to, transaction party information, transaction content or related information, donee data, ancillary data, and the like. It will be apparent to those of ordinary skill in the art that the donative transfer system database 112 can be locally resident at the host site 110 or remotely located at other server locations or stored in network cloud storage.

Referring again to FIG. 1, host site 110 of an example embodiment is shown to include the donative transfer system 200. In an example embodiment, donative transfer system 200 can include a transaction party interface processing module 210 and a donee interface processing module 220. Each of these modules can be implemented as software components executing within an executable environment of donative transfer system 200 operating on host site 110 or user platform 140. Each of these modules of an example embodiment is described in more detail below in connection with the figures provided herein.

Referring still to FIG. 1, the donative transfer system 200 can include a transaction party interface processing module 210 and a donee interface processing module 220. The transaction party interface processing module 210 can facilitate communication and the transfer of data, transaction information, and documents between a user at a transaction party platform 120 and the host site 110. The donee interface processing module 220 can facilitate communication and the transfer of data, donation information, and documents between a donee platform 130 and the host site 110. The transaction party interface processing module 210 and the donee interface processing module 220 can be configured to perform the processing as described in more detail below. The transaction party interface processing module 210 can be resident at the host site 110, resident on a transaction party platform 120, or partially resident on a plurality of user platforms 140. Similarly, the donee interface processing module 220 can be resident at the host site 110, resident on a donee platform 130, or partially resident on a plurality of user platforms 140. The donative transfer system 200 be configured to provide data communications for the transaction party platforms 120, the donee platforms 130, and the central database 3 to enable the networked usage, distribution, disclosure, transfer, or downloading of transaction information, requests, images, documents, and related data to facilitate the authorized settlement of a transaction with a donative element. The components and processes for the authorized settlement of a transaction with a donative element embodied in the transaction party interface processing module 210, the donee interface processing module 220, and the central database 3 are described in more detail below.

An example embodiment provides a system and method that allows a party at a transaction party platform 120 to make at least one set of conditional computer programming instructions (in that agreement or separately under it) to a central processing unit (e.g., host site 110), providing for the transfer of money or other property for less than full consideration to an organization (e.g., donee) identified from the central database 3 as part of the settlement. In accordance with the settlement agreement, at least one transaction party will make that donative transfer. Pursuant to the settlement agreement, the parties to the negotiation will be afforded access to electronic evidence of the donation and the settlement.

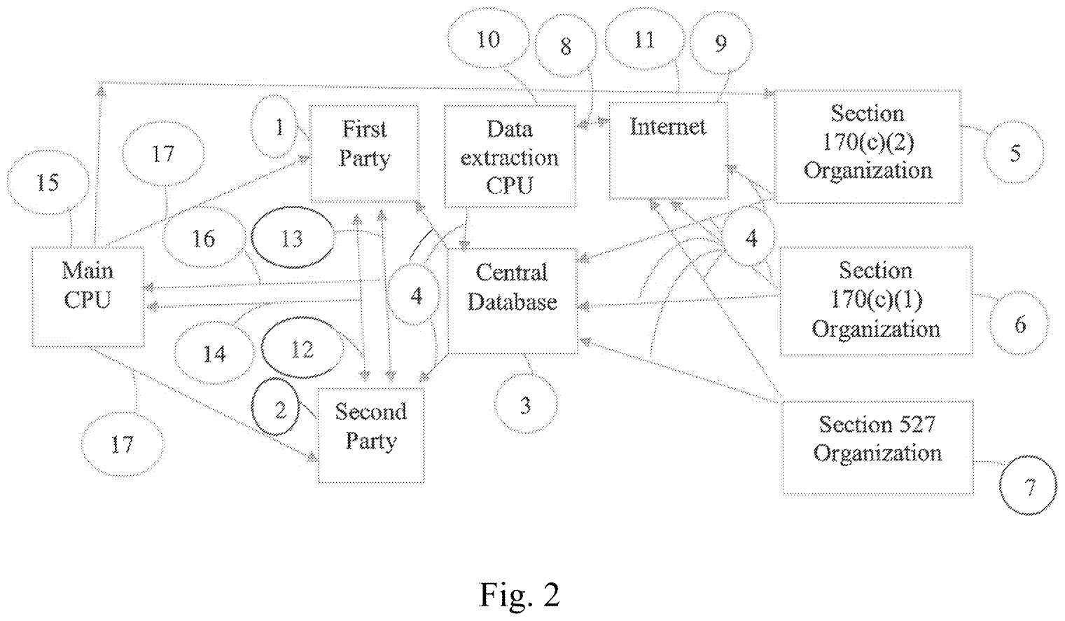

Referring now to FIG. 2, an example embodiment provides a system and method of encouraging donative transfers through settlements and computer systems used to effect donative transfers in connection with negotiation or transaction settlement. Referring again to FIG. 2, the schematic or data flow diagram shows an information or data processing flow for an example embodiment, in which one donee (e.g., alternatively donees 5, 6, or 7) and two transaction parties (e.g., first party 1 and second party 2) are involved in a settlement agreement, litigation matter, or other transaction negotiation, for which one or both of the two transaction parties (e.g., first party 1 or second party 2) make a settlement payment to one or more donees (e.g., alternatively donee 5, 6, or 7) as part of the settlement of the transaction or negotiation. The particular example embodiment shown may not involve any third party information recipient. As shown in FIG. 2, first party 1 and second party 2 have data network access to central database 3 storing information 4 related to available Section 170(c)(2) Organizations 5, Section 170(c)(1) Organizations 6, and/or Section 527 Organizations 7 (e.g., the available donees). Information 4 related to the available donees 5, 6, or 7 can be obtained or extracted 8 from the Internet 9, corresponding to network 115, with a data extraction central processing unit (CPU) 10, such as host 110 or a data processor of transaction party platforms 120. Using the donee information accessed or obtained via the central database 3, the first party 1 and second party 2 can agree on or select one or more particular donees 5, 6, or 7 that will be a recipient of a donative transfer of value from either or both of the first party 1 and/or second party 2 as part of settlement of the negotiation or transaction. The donee information 4 is reasonably necessary for the transaction parties 1 and 2 to make a decision regarding a donative transfer 11 that is a condition of performance under a settlement agreement 12. The donative transfer system 200 or CPU 10 can also be configured to automatically select one or more donees to receive the donative transfer of value. Moreover, the donative transfer system 200 or CPU 10 can also be configured to automatically select one or more donees to receive the donative transfer of value based on matching characteristics or affinities of the available donees with characteristics or affinities of transaction parties at the plurality of transaction party platforms. The donative transfer 11 provides for or is an element of contractual or settlement performance through an exchange of valuable consideration 13 between one or both transaction parties 1 and 2. The donative transfer 11 can include conditional programing instructions 14 to a CPU (the “Main CPU”) 15 (such as host 110 or a data processor of transaction party platforms 120) that executes the instructions necessary for the electronic portion of contractual or settlement performance and completion of the donative transfer 11. Once the donative transfer 11 is complete, the Main CPU 15 (such as host 110 or a data processor of transaction party platforms 120) receives or generates information 16 indicating that the exchange of valuable consideration 13, and other necessary performance, between transaction parties 1 and 2 has occurred. When the Main CPU 15 (such as host 110 or a data processor of transaction party platforms 120) determines that the donative transfer 11 is complete and the exchange of valuable consideration 13, and other necessary performance, between transaction parties 1 and 2 has occurred, the Main CPU 15 (such as host 110 or a data processor of transaction party platforms 120) receives or generates confirmation or evidentiary information indicative of completion of the donative transfer 11 and completion of other necessary settlement or transaction performance. The Main CPU 15 (such as host 110 or a data processor of transaction party platforms 120) can send the confirmation or evidentiary information as contractual performance evidence 17 verifying completion of contractual or transaction performance to the first party 1 and second party 2. As a result, the negotiation, settlement, or transaction between first party 1 and second party 2 is complete.

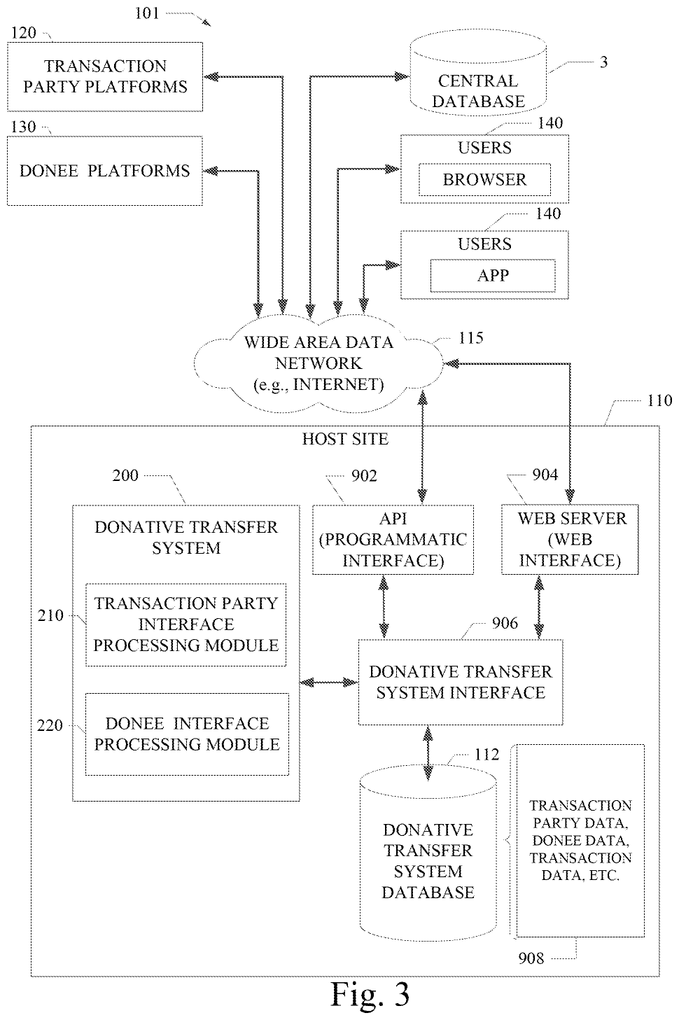

Referring now to FIG. 3, another example embodiment 101 of a networked system in which various embodiments may operate is illustrated. In the embodiment illustrated, the host site 110 is shown to include the donative transfer system 200. The donative transfer system 200 is shown to include the transaction party interface processing module 210 and the donee interface processing module 220 as described above. The network-connected central database 3 is also shown. In a particular embodiment, the host site 110 may also include a web server 904, having a web interface with which users may interact with the host site 110 via a user interface or web interface. The host site 110 may also include an application programming interface (API) 902 with which the host site 110 may interact with other network entities on a programmatic or automated data transfer level. The API 902 and web interface 904 may be configured to interact with the donative transfer system 200 either directly or via an interface 906. The donative transfer system 200 may be configured to access a data storage device 112 either directly or via the interface 906.

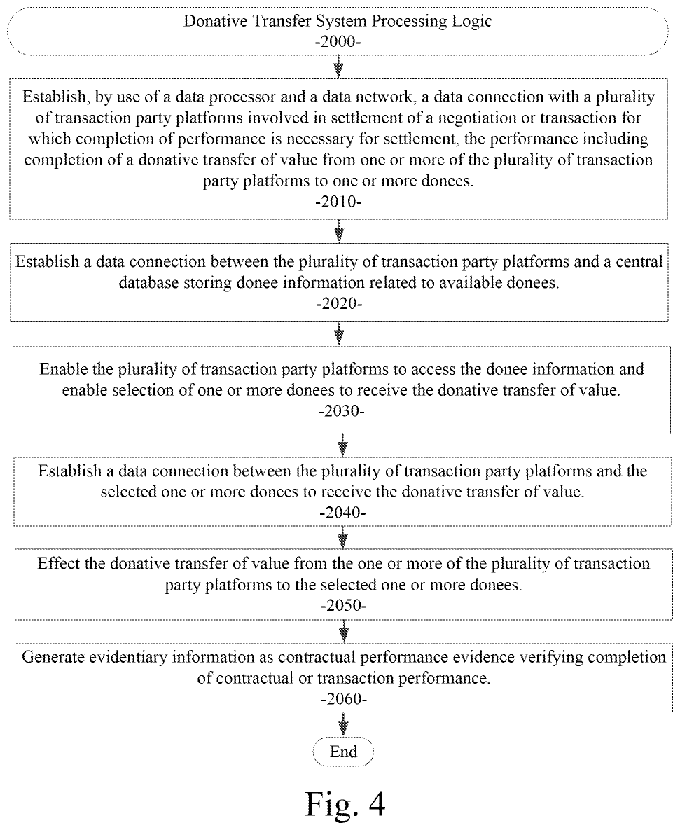

Referring now to FIG. 4, a processing flow diagram illustrates an example embodiment of a method implemented by the donative transfer system 200 as described herein. The method 2000 of an example embodiment can include: establishing, by use of a data processor and a data network, a data connection with a plurality of transaction party platforms involved in settlement of a negotiation or transaction for which completion of performance is necessary for settlement, the performance including completion of a donative transfer of value from one or more of the plurality of transaction party platforms to one or more donees (processing block 2010); establishing a data connection between the plurality of transaction party platforms and a central database storing donee information related to available donees (processing block 2020); enabling the plurality of transaction party platforms to access the donee information and enabling selection of one or more donees to receive the donative transfer of value (processing block 2030); establishing a data connection between the plurality of transaction party platforms and the selected one or more donees to receive the donative transfer of value (processing block 2040); effecting the donative transfer of value from the one or more of the plurality of transaction party platforms to the selected one or more donees (processing block 2050); and generating evidentiary information as contractual performance evidence verifying completion of contractual or transaction performance (processing block 2060).

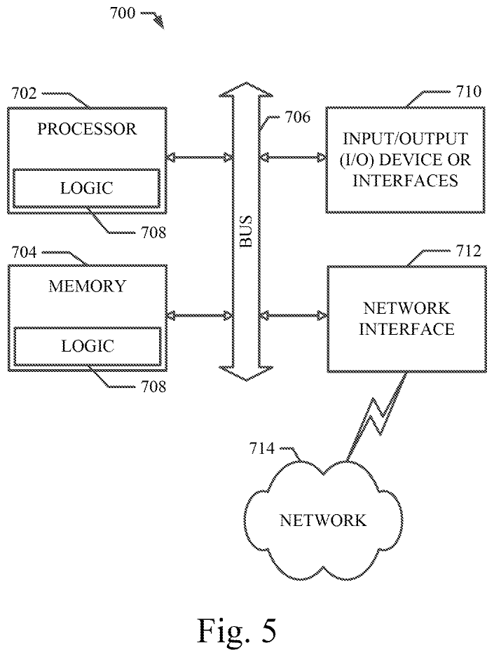

FIG. 5 shows a diagrammatic representation of a machine in the example form of a mobile computing and/or communication system 700 within which a set of instructions when executed and/or processing logic when activated may cause the machine to perform any one or more of the methodologies described and/or claimed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a laptop computer, a tablet computing system, a Personal Digital Assistant (PDA), a cellular telephone, a smartphone, a mobile device, a web appliance, a network router, switch or bridge, or any machine capable of executing a set of instructions (sequential or otherwise) or activating processing logic that specify actions to be taken by that machine. Further, while only a single machine is illustrated, the term “machine” can also be taken to include any collection of machines that individually or jointly execute a set (or multiple sets) of instructions or processing logic to perform any one or more of the methodologies described and/or claimed herein.

The example mobile computing and/or communication system 700 includes a data processor 702 (e.g., a System-on-a-Chip (SoC), general processing core, graphics core, and optionally other processing logic) and a memory 704, which can communicate with each other via a bus or other data transfer system 706. The mobile computing and/or communication system 700 may further include various input/output (I/O) devices and/or interfaces 710, such as a touchscreen display and optionally a network interface 712. In an example embodiment, the network interface 712 can include one or more radio transceivers configured for compatibility with any one or more standard wireless and/or cellular protocols or access technologies (e.g., 2nd (2G), 2.5, 3rd (3G), 4th (4G) generation, and future generation radio access for cellular systems. Global System for Mobile communication (GSM), General Packet Radio Services (GPRS), Enhanced Data GSM Environment (EDGE), Wideband Code Division Multiple Access (WCDMA), LTE, CDMA2000, WLAN, Wireless Router (WR) mesh, and the like), Network interface 712 may also be configured for use with various other wired and/or wireless communication protocols, including TCP/IP, UDP, SIP, SMS, RTP, WAP, CDMA, TDMA, UMTS, UWB, WiFi, WiMax, Bluetooth™, IEEE 802.11x, and the like. In essence, network interface 712 may include or support virtually any wired and/or wireless communication mechanisms by which information may travel between the mobile computing and/or communication system 700 and another computing or communication system via network 714.

The memory 704 can represent a machine-readable medium on which is stored one or more sets of instructions, software, firmware, or other processing logic (e.g., logic 708) embodying any one or more of the methodologies or functions described and/or claimed herein. The logic 708, or a portion thereof, may also reside, completely or at least partially within the processor 702 during execution thereof by the mobile computing and/or communication system 700. As such, the memory 704 and the processor 702 may also constitute machine-readable media. The logic 708, or a portion thereof, may also be configured as processing logic or logic, at least a portion of which is partially implemented in hardware. The logic 708, or a portion thereof, may further be transmitted or received over a network 714 via the network interface 712. While the machine-readable medium of an example embodiment can be a single medium, the term “machine-readable medium” should be taken to include a single non-transitory medium or multiple non-transitory media (e.g., a centralized or distributed database, and/or associated caches and computing systems) that stores the one or more sets of instructions. The term “machine-readable medium” can also be taken to include any non-transitory medium that is capable of storing, encoding or carrying a set of instructions for execution by the machine and that cause the machine to perform any one or more of the methodologies of the various embodiments, or that is capable of storing, encoding or carrying data structures utilized by or associated with such a set of instructions. The term “machine-readable medium” can accordingly be taken to include, but not be limited to, solid-state memories, optical media, and magnetic media.

In the various example embodiments disclosed herein, a system and method of encouraging donative transfers through settlements and computer systems used to effect donative transfers in connection with negotiation settlement is described. In the various example embodiments described herein, a computer-implemented tool or software application (app) as part of a donative transfer system is described to automate and improve the interaction and settlement of negotiations or transactions between parties according to the mutual direction of the transaction parties. As such, the various embodiments as described herein are necessarily rooted in computer processing, data storage, and network technology and serve to improve these technologies when applied in the manner as presently claimed. In particular, the various embodiments described herein improve the use of data storage technology and data network technology in the context of electronic communication, transaction data storage and access, and generation of evidentiary information verifying completion of transaction performance.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A system comprising:
a data processor;
a network interface, in data communication with the data processor, for communication on a data network; and
a donative transfer system, executable by the data processor, to:
establish, by use of the data processor and the data network, a data connection with a plurality of transaction party platforms involved in settlement of a negotiation or transaction for which completion of performance is necessary for settlement, the performance including completion of a donative transfer of value from one or more of the plurality of transaction party platforms to one or more donees;
establish, by use of the data processor and the data network, a data connection between the plurality of transaction party platforms and a central database storing donee information related to available donees;
enable, by use of the data processor and the data network, the plurality of transaction party platforms to access the donee information and enable selection of one or more donees to receive the donative transfer of value;
establish, by use of the data processor and the data network, a data connection between the plurality of transaction party platforms and the selected one or more donees to receive the donative transfer of value;
effect, by use of the data processor and the data network, the donative transfer of value from the one or more of the plurality of transaction party platforms to the selected one or more donees; and
generate, by use of the data processor and the data network, evidentiary information as contractual performance evidence verifying completion of contractual or transaction performance.

2. The system of claim 1 being further configured to cryptographically encrypt, by use of the data processor, the contractual performance evidence.

3. The system of claim 1 being further configured to store the contractual performance evidence on a blockchain.

4. The system of claim 1 wherein the available donees are charitable organizations, governmental organizations, or political organizations.

5. The system of claim 1 wherein the negotiation or transaction is a contract negotiation, a litigation settlement, or a transaction dispute.

6. The system of claim 1 wherein the one or more donees selected to receive the donative transfer of value are automatically selected by the donative transfer system.

7. The system of claim 1 wherein the one or more donees selected to receive the donative transfer of value are automatically selected by the donative transfer system based on matching characteristics or affinities of the available donees with characteristics or affinities of transaction parties at the plurality of transaction party platforms.

8. The system of claim 1 wherein the data connection between the plurality of transaction party platforms and the selected one or more donees to receive the donative transfer of value is an application programming interface (API).

9. A computer-implemented method comprising:
establishing, by use of a data processor and a data network, a data connection with a plurality of transaction party platforms involved in settlement of a negotiation or transaction for which completion of performance is necessary for settlement, the performance including completion of a donative transfer of value from one or more of the plurality of transaction party platforms to one or more donees;
establishing, by use of the data processor and the data network, a data connection between the plurality of transaction party platforms and a central database storing donee information related to available donees;
enabling, by use of the data processor and the data network, the plurality of transaction party platforms to access the donee information and enabling selection of one or more donees to receive the donative transfer of value;
establishing, by use of the data processor and the data network, a data connection between the plurality of transaction party platforms and the selected one or more donees to receive the donative transfer of value;
effecting, by use of the data processor and the data network, the donative transfer of value from the one or more of the plurality of transaction party platforms to the selected one or more donees; and
generating, by use of the data processor and the data network, evidentiary information as contractual performance evidence verifying completion of contractual or transaction performance.

10. The method of claim 9 including cryptographically encrypting, by use of the data processor, the contractual performance evidence.

11. The method of claim 9 including storing the contractual performance evidence on a blockchain.

12. The method of claim 9 wherein the available donees are charitable organizations, governmental organizations, or political organizations.

13. The method of claim 9 wherein the negotiation or transaction is a contract negotiation, a litigation settlement, or a transaction dispute.

14. The method of claim 9 wherein the one or more donees selected to receive the donative transfer of value are automatically selected by the donative transfer system.

15. The method of claim 9 wherein the one or more donees selected to receive the donative transfer of value are automatically selected by the donative transfer system based on matching characteristics or affinities of the available donees with characteristics or affinities of transaction parties at the plurality of transaction party platforms.

16. The method of claim 9 wherein the data connection between the plurality of transaction party platforms and the selected one or more donees to receive the donative transfer of value is an application programming interface (API).

17. A non-transitory machine-useable storage medium embodying instructions which, when executed by a machine, cause the machine to:
establish, by use of a data processor and a data network, a data connection with a plurality of transaction party platforms involved in settlement of a negotiation or transaction for which completion of performance is necessary for settlement, the performance including completion of a donative transfer of value from one or more of the plurality of transaction party platforms to one or more donees;
establish, by use of the data processor and the data network, a data connection between the plurality of transaction party platforms and a central database storing donee information related to available donees;
enable, by use of the data processor and the data network, the plurality of transaction party platforms to access the donee information and enable selection of one or more donees to receive the donative transfer of value;
establish, by use of the data processor and the data network, a data connection between the plurality of transaction party platforms and the selected one or more donees to receive the donative transfer of value;
effect, by use of the data processor and the data network, the donative transfer of value from the one or more of the plurality of transaction party platforms to the selected one or more donees; and
generate, by use of the data processor and the data network, evidentiary information as contractual performance evidence verifying completion of contractual or transaction performance.

18. The non-transitory machine-useable storage medium of claim 17 wherein the available donees are charitable organizations, governmental organizations, or political organizations.

19. The non-transitory machine-useable storage medium of claim 17 wherein the negotiation or transaction is a contract negotiation, a litigation settlement, or a transaction dispute.

20. The non-transitory machine-useable storage medium of claim 17 wherein the one or more donees selected to receive the donative transfer of value are automatically selected by the donative transfer system.
